(19) United States
(12) Patent Application Publication
(10) Pub. No.: US 2023/0205395 A1
(43) Pub. Date: Jun. 29, 2023

(54) SYSTEM AND METHOD FOR ENABLING ACCESS TO HIDDEN MENUS ON A DISPLAY SCREEN

(71) Applicant: PEER INC, Bellevue, WA (US)

(72) Inventor: Thinh Tran, Bellevue, WA (US)

(21) Appl. No.: 18/068,429

(22) Filed: Dec. 19, 2022

Related U.S. Application Data
(60) Provisional application No. 63/294,356, filed on Dec. 28, 2021.

(51) Int. Cl. G06F 3/0482; G06F 3/14; G06F 3/041; G06F 3/04886

(52) U.S. Cl. CPC G06F 3/0482; G06F 3/1423; G06F 3/0414; G06F 3/04886; G06F 2203/04806; G06F 2203/04108

(57) ABSTRACT

A multi-dimensional fabric user interface is described herein in which a accessing hidden menus to zoom using a dynamic grid. The system activates a hidden menu on a display screen, in response to receiving a pressure input user action on a user interface. The hidden menu including active regions and inactive regions. Next, the system also causes movement of a cursor over the hidden menu on the user interface, in response to receiving a motion input user action on the user interface. The system performs an operation associated with a utility, in response to receiving the pressure user action if the cursor on the hidden menu is over an active region. Then the system de-activates the hidden menu, in response to receiving the pressure user action.

### TECHNICAL FIELD

The present application pertains to systems that enable access to hidden menus, and more particularly, to systems that enable access to hidden menus on a display screen.

### BACKGROUND

### Description of the Related Art

Operating systems have changed little over the past few decades. Early operating systems were command driven, where a user specified a particular file location to access data. These operating systems morphed into the icon-based interfaces used today. Icon-based operating systems display graphical representations, or icons, of files or data. Icons are associated with a particular file location, such that interaction with an icon by a user results in the corresponding file location being accessed. Accordingly, historical operating systems have been structured around using the file's location within the memory to access data, which limits the flexibility of using alternative storage structures.

Furthermore, there is also a desire among users to interact with information that is presented on larger display screens. Traditional means of interacting with such larger screens have proved unsatisfactory, particularly when the larger display screens do not have a previous secured information transfer link with a user input device. The present disclosure address this and other needs.

### BRIEF SUMMARY

Briefly stated, embodiments of the present disclosure are directed towards systems for accessing hidden menus on a display screen. Some such embodiments include a personal mobile computing device that stores authentication information, and includes a touch screen, a device memory that stores device computer instructions, and a device processor. The device processor executes the device computer instructions and causes the personal mobile computing device to: coordinate authentication between the personal mobile computing device and a display screen; receive a pressure input user action on a user interface; activate a hidden menu on a display screen, in response to receiving the pressure input user action on a user interface, the hidden menu including active regions and inactive regions, the active regions including utilities that are selectable and activatable via user input; receive a motion input user action on the user interface; cause movement of a cursor over the hidden menu on the user interface, in response to receiving the motion input user action on the user interface; receive a pressure user action on a user interface; perform an operation associated with a utility, in response to receiving the pressure user action if the cursor on the hidden menu is over an active region; and de-activate the hidden menu, in response to receiving the pressure user action if the cursor on the hidden menu is over an inactive region; and wherein the pressure input user action, the motion input user action, and the pressure user action are all part of a touch and user action by a user. The pressure input action is an applied pressure in some embodiments, and is a released pressure in other embodiments. Similarly, the pressure user action is a released pressure in some embodiments, and is an applied pressure in other embodiments. For example, in one embodiment, the pressure user action is an applied pressure, in another embodiment, the pressure user action is a pressure release.

In some embodiments, the device processor executes further device computer instructions that cause the system to enable activation of a utility in response to the user moving the cursor over an active region of the hidden menu. In other embodiments, the utility activated in response to the user moving the cursor over an active region of the hidden menu is a zoom feature. In another aspect of some embodiments, the pressure user action performed for the zoom feature utility if the cursor on the hidden menu is over an active region is locking the zoom feature utility to be enabled.

In one or more other embodiments, the pressure user action performed for the zoom feature utility if the cursor on the hidden menu is over an inactive region is deactivating the zoom feature and returning to a non-zooming mode. In another aspect of some embodiments, the operation associated with the pressure user action on the user interface is the activation of the utility. In still another aspect of some embodiments, the hidden menu on a display screen is positioned at a location associated with the received pressure input user action on a user interface.

In some embodiments, the hidden menu on a display screen is positioned at a predetermined location that is not associated with the received pressure input user action on a user interface. In other embodiments, the display screen upon which the hidden menu is launched is on one or more of an associated large display screen of an electronic device, a display screen of the personal mobile computing device, and multiple connected display screens. In still another aspect of some embodiments, the display screen upon which the hidden menu is launched is on one or more of a smart watch, a mobile phone, a tablet computer, a desktop computer, a large screen television, and a large screen monitor.

Embodiments of the present disclosure are also directed towards a method for accessing hidden menus on a display screen. Such methods include: accessing a personal mobile computing device, the personal mobile computing device including a device memory that stores device computer instructions and a device processor that executes the device computer instructions; receiving a pressure input user action on a user interface; activating a hidden menu on a display screen, in response to receiving the pressure input user action on a user interface, the hidden menu including active regions and inactive regions, the active regions including utilities that are selectable and activatable via user input; receiving a motion input user action on the user interface; causing movement of a cursor over the hidden menu on the user interface, in response to receiving the motion input user action on the user interface; receiving a pressure user action on a user interface; performing an operation associated with a utility, in response to receiving the pressure user action if the cursor on the hidden menu is over an active region; and de-activating the hidden menu, in response to receiving the pressure user action if the cursor on the hidden menu is over an inactive region; wherein the pressure input user action, the motion input user action, and the pressure user action are all part of a touch and user action by a user.

In some embodiments, the device processor executes further device computer instructions that cause the system to enable activation of a utility in response to the user moving the cursor over an active region of the hidden menu. In other embodiments, the utility activated in response to the user moving the cursor over an active region of the hidden menu is a zoom feature. In another aspect of some embodiments, the pressure user action performed for the zoom feature utility if the cursor on the hidden menu is over an active region is locking the zoom feature utility to be enabled.

In one or more other embodiments, the pressure user action performed for the zoom feature utility if the cursor on the hidden menu is over an inactive region is deactivating the zoom feature and returning to a non-zooming mode. In another aspect of some embodiments, the operation associated with the pressure user action on the user interface is the activation of the utility. In still another aspect of some embodiments, the hidden menu on a display screen is positioned at a location associated with the received pressure input user action on a user interface.

In some embodiments, the hidden menu on a display screen is positioned at a predetermined location that is not associated with the received pressure input user action on a user interface. In other embodiments, the display screen upon which the hidden menu is launched is on one or more of an associated large display screen of an electronic device, a display screen of the personal mobile computing device, and multiple connected display screens. In still another aspect of some embodiments, the display screen upon which the hidden menu is launched is on one or more of a smart watch, a mobile phone, a tablet computer, a desktop computer, a large screen television, and a large screen monitor.

Still other embodiments of the present disclosure are directed towards systems for accessing hidden menus on a display screen. Such systems include a personal mobile computing device and a remote server. The personal mobile computing device stores authentication information, and includes a touch screen, a device memory that stores device computer instructions, and a device processor. The device processor executes the device computer instructions and causes the personal mobile computing device to: activate a hidden menu on a display screen, in response to receiving a pressure input user action on a user interface, the hidden menu including active regions and inactive regions, the active regions including utilities that are selectable and activatable via user input; cause movement of a cursor over the hidden menu on the user interface, in response to receiving a motion input user action on the user interface; perform an operation associated with a utility, in response to receiving the pressure user action if the cursor on the hidden menu is over an active region; and de-activate the hidden menu, in response to receiving the pressure user action.

The embodiments described in the present disclosure improve upon known data storage architectures, structures, processes, and techniques in a variety of different computerized technologies, such as operating systems, user interfaces, and social networks.

### BRIEF DESCRIPTION OF THE SEVERAL VIEWS OF THE DRAWINGS

Non-limiting and non-exhaustive embodiments are described with reference to the following drawings. In the drawings, like reference numerals refer to like parts throughout the various figures unless otherwise specified.

For a better understanding, reference will be made to the following Detailed Description, which is to be read in association with the accompanying drawings:

FIG. 1 illustrates a context diagram of an environment that provides a user interface for moving a cursor on an associated large display device in accordance with embodiments described herein;

FIG. 2 illustrates a graphical representation in accordance with embodiments described herein;

FIG. 3 illustrates another graphical representation in accordance with embodiments described herein;

FIG. 4A illustrates a logical flow diagram generally showing one embodiment of a process for accessing a remote server from a display device in accordance with embodiments described herein;

FIG. 4B illustrates a logical flow diagram generally showing one embodiment of a process for moving a cursor on an associated large display device;

FIG. 5 illustrates a personal display device with a touch screen to receive user input with a hidden menu launched;

FIG. 6A illustrates a large display device that is receiving cursor movement information with a hidden menu not yet launched;

FIG. 6B illustrates a large display device that is receiving cursor movement information with a hidden menu launched;

FIG. 7 illustrates a logic diagram that displays a process for receiving user input on a touch screen for accessing hidden menus and their active regions;

FIG. 8 illustrates a personal display device with a touch screen to receive user input and grid lines;

FIG. 9 illustrates a larger display device that is receiving cursor movement information and grid lines;

FIG. 10 illustrates a large display device that is receiving cursor movement information and grid lines;

FIG. 11 illustrates a logic diagram that displays a process for receiving user input on a touch screen with dynamic grid density and uses this input to coordinate cursor movement on an associated larger display device; and

FIG. 12 illustrates a system diagram that describes one implementation of computing systems for implementing embodiments described herein.

### DETAILED DESCRIPTION

The following description, along with the accompanying drawings, sets forth certain specific details in order to provide a thorough understanding of various disclosed embodiments. However, one skilled in the relevant art will recognize that the disclosed embodiments may be practiced in various combinations, without one or more of these specific details, or with other methods, components, devices, materials, etc. In other instances, well-known structures or components that are associated with the environment of the present disclosure, including but not limited to the communication systems and networks and the automobile environment, have not been shown or described in order to avoid unnecessarily obscuring descriptions of the embodiments. Additionally, the various embodiments may be methods, systems, media, or devices. Accordingly, the various embodiments may be entirely hardware embodiments, entirely software embodiments, or embodiments combining software and hardware aspects.

Throughout the specification, claims, and drawings, the following terms take the meaning explicitly associated herein, unless the context clearly dictates otherwise. The term “herein” refers to the specification, claims, and drawings associated with the current application. The phrases “in one embodiment,” “in another embodiment,” “in various embodiments,” “in some embodiments,” “in other embodiments,” and other variations thereof refer to one or more features, structures, functions, limitations, or characteristics of the present disclosure, and are not limited to the same or different embodiments unless the context clearly dictates otherwise. As used herein, the term “or” is an inclusive “or” operator, and is equivalent to the phrases “A or B, or both” or “A or B or C, or any combination thereof,” and lists with additional elements are similarly treated. The term “based on” is not exclusive and allows for being based on additional features, functions, aspects, or limitations not described, unless the context clearly dictates otherwise. In addition, throughout the specification, the meaning of “a,” “an,” and “the” include singular and plural references.

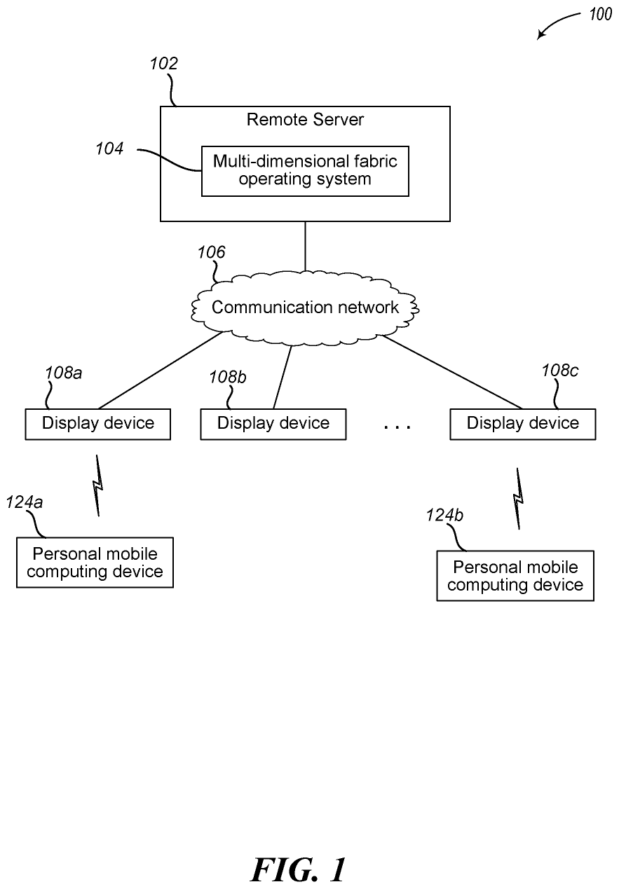

FIG. 1 illustrates a context diagram of system 100 that provides a multi-dimensional fabric user interface for storing content in accordance with embodiments described herein. In the illustrated example, system 100 includes a remote server 102, one or more display devices 108a-108c, and one or more personal mobile computing devices 124a, 124b. In some embodiments, the system 100 is used to access hidden menus on one or more display devices 108a-108c.

The remote server 102 in the system 100 is configured as a remote computing system, e.g., cloud computing resources, which implements or executes a multi-dimensional fabric operating system 104. In various embodiments, a separate instance of the multi-dimensional fabric operating system 104 is maintained and executing for each separate personal mobile computing device 124a, 124b. In some embodiments, the multi-dimensional fabric user interface may be implemented as an operating shell.

Although not illustrated, the remote server 102 may also be running various programs that are accessible to the users of the personal mobile computing devices 124a, 124b via the multi-dimensional fabric operating system 104. Accordingly, the environment and system described herein make it possible for a plurality of applications to be run in the cloud, and a user accesses a particular application by moving the fabric to that application's coordinates.

The multi-dimensional fabric operating system 104 stores content according to a plurality of different dimensions. In some embodiments, the content is stored based on when the content was captured by the user or when it was stored by the remote server 102 (e.g., a time stamp added to a picture when the picture was captured or a time stamp when the picture was uploaded to the remote server), where the content was captured by the user (e.g., the location of the camera that captured the picture or a location of a display device used to upload the picture from the camera to the remote server), and what the content is about (e.g., food, clothing, entertainment, transportation, etc.).

A user in the system can access the multi-dimensional fabric operating system 104 via a display device 108a. The user has a personal mobile computing device 124, which can create or obtain content. The user can walk up to or approach a display device 108. The display device 108 coordinates authentication of the personal mobile computing device 124 with the remote server 102. The user can then use the display device 108 as a personal computer to upload content from the personal mobile computing device 124 to the remote server 102 using the multi-dimensional fabric operating system 104. Similarly, the user can use the display device 108 to access content previously stored by the multi-dimensional fabric operating system 104. For example, the user can use hand gestures, or touch interfaces, to provide input that manipulates a user interface displayed on the display device 108, where the user interface is generated by the multi-dimensional fabric operating system 104. The remote server 102 can respond to the input by providing an updated user interface of the multi-dimensional fabric to the display device 108 for display to the user. Notably, the user may transmit between the personal mobile computing device 124b and the remote server 102 via the communication network 106, without connecting to a display device 108 in some embodiments.

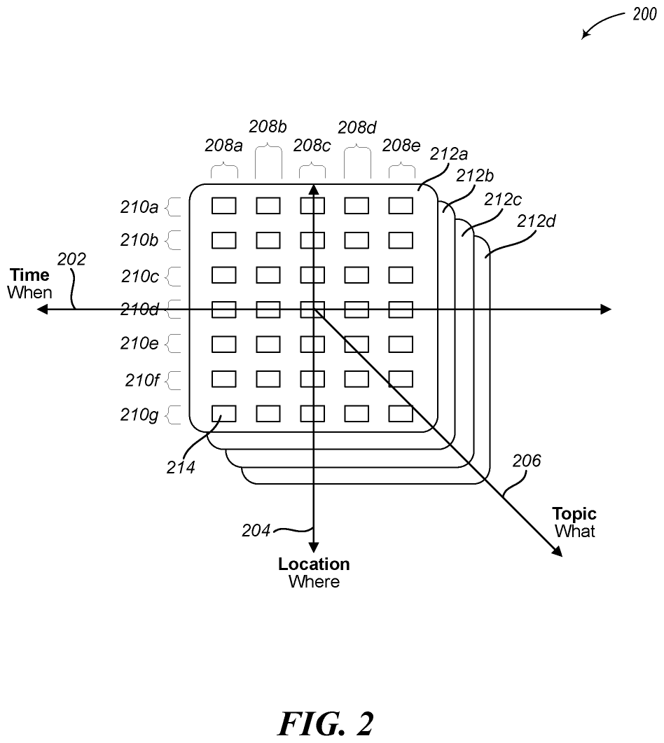

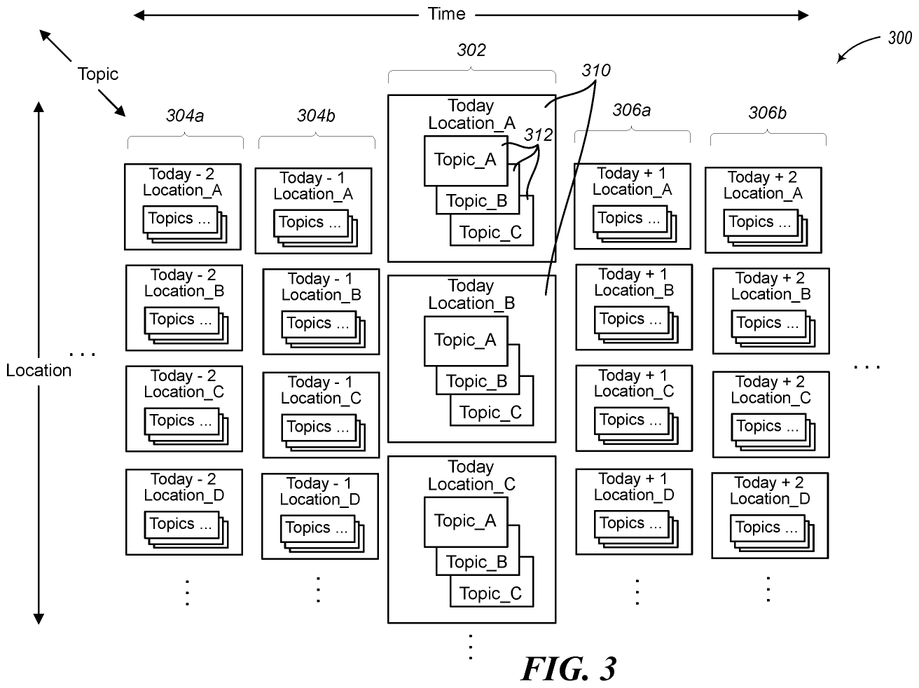

FIGS. 2 and 3 illustrate graphical representations of use case examples of a multi-dimensional fabric user interface for storing content in accordance with embodiments described herein.

Example fabric 200 in FIG. 2 includes a time axis 202, a location axis 204, and a topic axis 206. Although fabric 200 appears to be constrained in each axis, embodiments are not so limited. Rather, fabric or graphical environment is flexible, while the coordinate is fixed. This allows a user to use cruder movements, like the swipe of an arm, to achieve refined movement to arrive at the content. This also reduces the content footprint because it does not need to manage a file structure, which improves throughput to a degree that it can run entirely in the cloud.

In some embodiments, users in the multi-dimensional fabric system navigate by moving the environment, or fabric, to a specific content or item. The content is placed within a 3-Dimensional structure of Time (when)+Location (where)+Topic (what), which may be in the form of a multi-dimensional coordinate system. By configuring the content in the fabric based on 3 dimensions (What, When, Where), the fabric provides a pre-configured scaffold that allows a user to navigate the plurality of content without the multi-dimensional fabric system fetching and organizing it. The fabric makes discovering more relevant content immediately accessible.

The time axis 202 in the multi-dimensional fabric system may be arranged as a plurality of different time periods, such as hours or days. In various embodiments, the current time period (e.g., today) is shown in the middle column 208c, which is shown in FIG. 3. The location axis 204 may be arranged as a plurality of different locations. In some embodiments, the content locations are selected based on a distance from a current location of the display device that is accessing the fabric 200. For example, locations closest to the display device are arranged in the top row 210a and the locations furthest from the display device are arranged in the bottom row 210g. Likewise, topics may be arranged based on themes nearest to the display device. For example, food content may be in layer 212a, entertainment content in layer 212b, transportation content in layer 212c, etc. In other embodiments, the topics may be arranged based on frequency of access to the user based on location.

The fabric 200 in the multi-dimensional fabric system illustrates a plurality of icons 214 that each represent separate content (also referred to as content 214). The content 214 is laid out in a plurality of time periods 208a-208e (columns), a plurality of locations 210a-210g (rows), and a plurality of topics 212a-212d (layers), using coordinates associated with the separate dimensions. For any given point defined by (What, When, Where) there is a finite amount of content or data. As a result, users can simply point out a certain What, When, and Where to know where something is located and can directly access it from that point.

In some embodiments of the multi-dimensional fabric system, the location rows 210, time columns 208, and topic layers may be independent from one another such that a user can manipulate a single axis. In other embodiments, the user can manipulate two or more axes. For example, a user can vertically scroll along the location axis 204 through a single column (e.g., single time period on the time axis), such as column 208c, without affecting the other columns or layers, or the user can vertically scroll along the location axis 204 for multiple columns or multiple layers, or both. Likewise, the user can horizontally scroll along the time axis 202 through a single row (e.g., single location on the location axis), such as row 210d, without affecting the other rows or layers, or the user can horizontally scroll along the time axis 202 for multiple rows or multiple layers, or both. Moreover, the user can depth scroll along the topic axis 206 through a single layer (e.g., single topic on the topic axis), such as layer 212a, without affecting the other rows or columns, or the user can depth scroll along the topic axis 206 for multiple rows or multiple columns, or both.

By providing input to one or more axes in the multi-dimensional fabric system, the user can manipulate or move the fabric 200 to access content for a specific time, a specific location, and a specific topic. The user can scroll on a particular axis by providing one or more hand gestures. For example, a horizontal movement of the user's arm may move the time axis 202, a vertical movement of the user's arm may move the location axis 204, and an in-or-out movement of the user's arm may move the topic axis 206. The user can then select a specific content 214, such as the content in the middle (along time and location axes) and on top (along the topic axis) of the fabric by moving their arm away from the display screen or by making a fist or by opening their hand.

In some embodiments of the multi-dimensional fabric system, the fabric will look two-dimensional to a user, but is actually three-dimensional, such that when a two-dimensional point is selected by the user, the user can switch axes to view the third dimension. And although FIG. 2 shows the time axis 202 and the location axis 204 on this top-level two-dimensional view, other combinations of axes may also be used, e.g., time v. topic, location v. topic, or other non-illustrated axes.

Example fabric 300 in FIG. 3 is similar to fabric 200 in FIG. 2, but is an example of how the fabric 300 can be displayable to a user. In this example illustration in FIG. 3, the current time period 302 is illustrated in a middle column with future time periods 306a, 306b to the right of the current time period 302 and past time periods 304a, 304b to the left of the current time period. Each location 310 in the current time period 302 includes a plurality of topics 312. These topics 312 are similar to the layers 212 in FIG. 2.

Again, the user in the multi-dimensional fabric system can move or manipulate the fabric 300 along one or more axes to select a particular piece of content. Once selected, the particular content is displayed to the user. Various embodiments of the multi-dimensional fabric described herein can be used for a variety of different content storage technologies. One example technology is the fluid timeline social network described in U.S. patent application Ser. No. 16/300,028, filed Nov. 8, 2018, titled FLUID TIMELINE SOCIAL NETWORK, and issued Aug. 18, 2020, as U.S. Pat. No. 10,747,414, which is incorporated herein by reference.

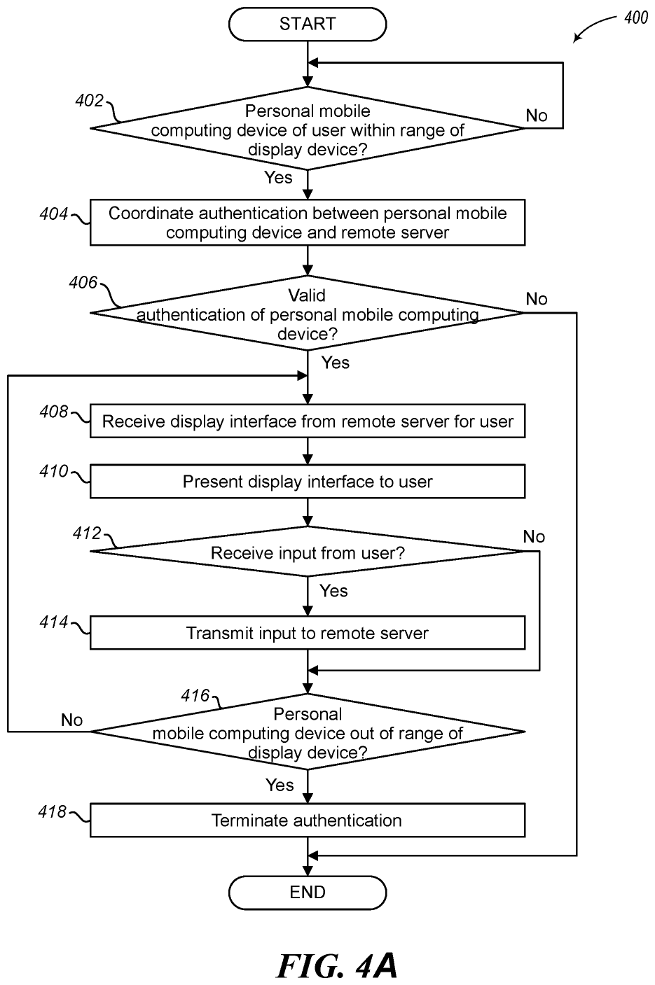

The operation of certain aspects of the disclosure will now be described with respect to FIGS. 4A and 4B. In at least one of various embodiments of the system, process 400 described in conjunction with FIG. 4A may be implemented by or executed by a system of one or more computing devices, such as display device 108 in FIG. 1, and process 500 described in conjunction with FIG. 4B may be implemented by or executed by a system of one or more remote computing devices, such as remote server 102.

FIG. 4A illustrates a logical flow diagram generally showing one embodiment of a process 400 for accessing a remote server from a display device to present a graphical user interface of a multi-dimensional fabric in accordance with embodiments described herein.

Process 400 begins, after a start block, at decision block 402, where a determination is made whether a personal mobile computing device of a user is within range of the display device. This determination may be made when the personal mobile computing device is within a threshold distance from the display device (e.g., using one or more range detection devices) or when the user indicates or requests to interact with the display device. If the personal mobile computing device is within range of the display device, then process 400 flows to block 404; otherwise process 400 loops to decision block 402 until a personal mobile computing device is within range of the display device.

At block 404, the display device coordinates authentication between the personal mobile computing device and a remote server. This coordination may include obtaining, requesting, or otherwise forwarding authentication keys or other information to determine the validity or authenticity of the personal mobile computing device as being authorized to access the remote server.

Process 400 proceeds to decision block 406, where a determination is made whether the personal mobile computing device is validly authenticated with the remote server. In some embodiments, the remote server may provide a token, session identifier, or other instruction to the display device indicating that the user of the personal mobile computing device is authorized to access the remote server via the display device. If the personal mobile computing device is valid, then process 400 flows to block 408; otherwise, process 400 terminates or otherwise returns to a calling process to perform other actions.

At block 408, the display device receives a display interface from the remote server for the user. In various embodiments, the display interface is customized for the user, such as if the user logged directly onto the remote server to access personal content. As described herein, this display interface is a multi-directional fabric that the user can manipulate, as described herein.

Process 400 continues at block 410, where the display device presents the display interface to the user of the personal mobile computing device. In some embodiments, the display interface is displayed directly by the display device. In other embodiments, the display interface is displayed via the personal mobile computing device.

Process 400 proceeds next to decision block 412, where a determination is made whether the display device has received input from the user. As described herein, the input may be provided via a hand gesture without touching a screen of the display device. Such hand gesture may be a swipe left or right, swipe up or down, or movement towards or away from the screen of the display device. A selection input can then be received if the user rapidly moves their hand away from the screen of the display device or if the user opens or closes his/her hand. If user input is received, then process 400 flows to block 414; otherwise, process 400 flows to decision block 416.

At block 414, the display device transmits the user input to the remote server. Process 400 proceeds to decision block 416, where a determination is made whether the personal mobile computing device is out of range of the display device (e.g., outside of a threshold distance or the user de-activated the session. If not, process 400 loops to block 408 to receive an updated or modified display interface (based on the user input) and present it to the user. If the personal mobile computing device is out of range of the display device, then process 400 flows to block 418 to terminate the authentication with the remote server.

After block 418, process 400 may terminate or otherwise return to a calling process to perform other actions. In some embodiments, process 400 may loop to decision block 402 to wait for another personal mobile computing device to be within range of the display device.

FIG. 4B illustrates a logical flow diagram generally showing one embodiment of a process 500 in the system for a remote server to provide a graphical user interface of a multi-dimensional fabric to a display device in accordance with embodiments described herein.

Process 500 begins, after a start block, at block 502, where an authentication request is received at a remote server from a display device for a personal mobile computing device of a user. In some embodiments, the authentication request may include encryption keys, user credentials, or other authentication information.

Process 500 proceeds to decision block 504, where a determination is made whether the personal mobile computing device is validly authenticated or not. If the personal mobile computing device is valid, process 500 flows to block 506; otherwise, process 500 terminates or otherwise returns to a calling process to perform other actions.

At block 500, the remote server selects a multi-dimensional fabric display interface for the user of the personal mobile computing device. In some embodiments, the remote server instantiates or accesses a previously running version of the multi-dimensional fabric operating system for the user. In various embodiments, each separate user (or a group of multiple users) has a corresponding multi-dimensional fabric user interface accessible via the remote server. The multi-dimensional fabric display interfaces with content laid out in a fabric-like structure based on at least time, location, and topic such that the user can manipulate or move the fabric in one or more dimensions to select content.

Process 500 proceeds to block 508, where the remote server provides the selected display interface to the display device for presentation to the user. Process 500 continues at decision block 510, where a determination is made whether user input has been received from the display device. In various embodiments, the input may be a change or selection of one or more dimensions of the fabric or a user selection. If user input has been received, process 500 flows to block 512; otherwise, process 500 flows to decision block 516

At block 512, the remote server manipulates the multi-dimensional fabric display interface based on the user input. In some embodiments, the manipulated display interface may include displaying specific content selected by the user. In other embodiments, the manipulated display interface may show a different section or area of the multi-dimensional fabric user interface based on the user input.

Process 500 proceeds next to block 514, where the remote server transmits the manipulated display interface to the display device. Process 500 continues next at decision block 516, where a determination is made whether the authentication of the personal mobile computing device has terminated. In some embodiments, the display device transmits a termination request to the remote server when the user of the personal mobile computing device walks away from or is out of range of the display device. If the authentication is terminated, process 550 terminates or otherwise returns to a calling process to perform other action; otherwise, process 500 loops to decision block 510 to receive additional user input from the display device.

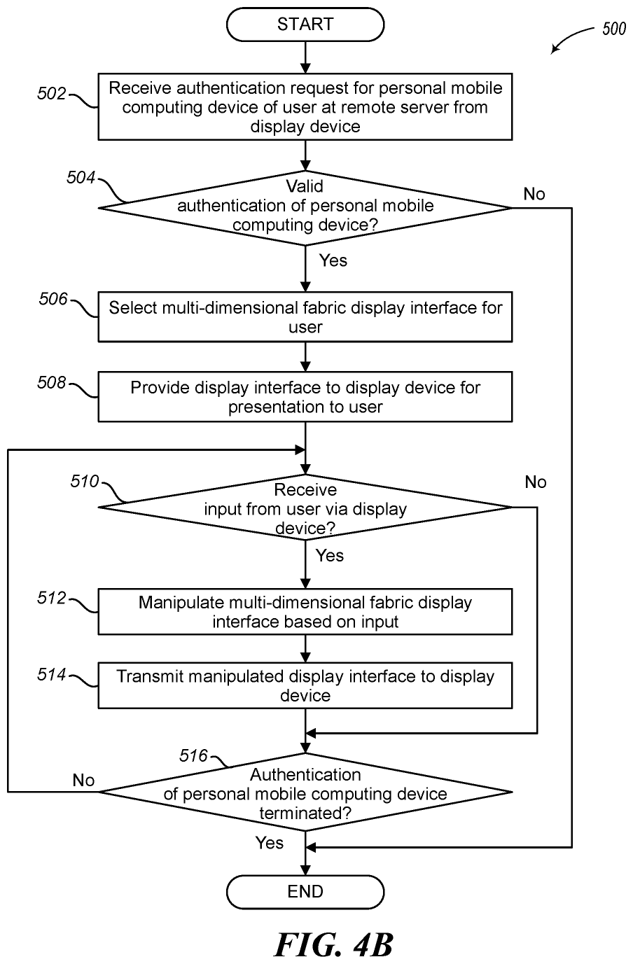

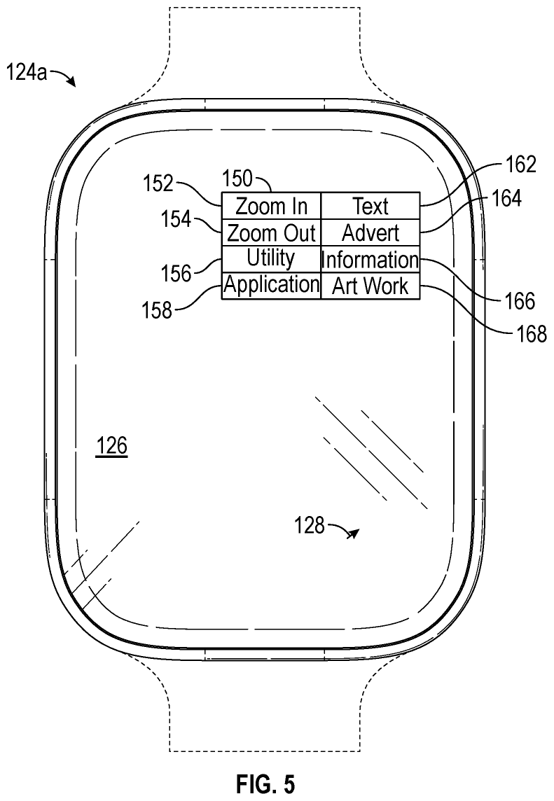

Referring now to FIGS. 1, 5, 6A, and 6B, some embodiments of a system for accessing hidden menus 150 on a display screen are shown. Some such embodiments include a personal mobile computing device 124a that stores authentication information, and includes a user interface (e.g., touch screen 126), a device memory that stores device computer instructions, and a device processor. The device processor executes the device computer instructions and causes the personal mobile computing device 124a to coordinate authentication between the personal mobile computing device 124a and the associated larger display screen 108a (i.e., enabling pairing of the personal mobile computing device 124a and the associated larger display screen 108a). The touch screen 126 is configured to receive a pressure input user action, such as a user finger press, a stylus press, a mouse press, as an applied pressure or a finger, stylus or mouse release as a released pressure or other user input selection on the touch screen 126. This pressure input user action causes the activation of a hidden menu 150 on the touch screen 126 of the personal mobile computing device 124a (as shown in FIG. 5) and/or activation of a hidden menu 170 on the display screen of the associated larger display screen 108a (as shown in FIG. 6B). The pressure input action can be either an applied pressure or a released pressure.

While in some embodiments, the user interface is the touch screen 126 on the personal mobile computing device 124a, in other embodiments, the user interface is located on a device other than the personal mobile computing device 124a, such as a mobile phone, a tablet computer, a desktop computer, a large screen television, or a large screen monitor.

In one or more embodiments, the hidden menu 150 on the touch screen 126 of the personal mobile computing device 124a includes active regions 152, 154, 156, and 158 (in FIG. 5) and inactive regions 162, 164, 166, and 168 (in FIG. 5). In an aspect of some embodiments, the active regions 152, 154, 156, and 158 include utilities or other applications that are selectable and activatable via user input. One such utility that is selectable and activatable is a zoom function that may be used to zoom in or zoom out on the touch screen 126 of the personal mobile computing device 124a. Other utilities in some embodiments enable settings changes on the display screen including, by way of example only, and not by way of limitation: brightness, contrast, tint, hue, color patterns, and the like. Still other utilities or applications may include, by way of example only, and not by way of limitation: input source selection of content, internet web navigation, log-in operations, authentication operations, mapping and directions operations, reservation operations, voice command operations, and help functions. In another aspect of some embodiments, the inactive regions 162, 164, 166, and 168 do not include utilities or other applications that are selectable and activatable via user input, but rather include inactive data or content including by way of example only, and not by way of limitation: text, advertisements, information, instructions, art work, designs, non-interactive content, and the like.

In other embodiments, the hidden menu 150 is still located on the touch screen 126 of the personal mobile computing device 124a, which includes active regions 152, 154, 156, and 158 (in FIG. 5) and inactive regions 162, 164, 166, and 168 (in FIG. 5). These active regions 152, 154, 156, and 158 still include utilities or other applications that are selectable and activatable via user input. However, in these embodiments, the utility that is selectable and activatable (e.g., a zoom function that may be used to zoom in or zoom out) affects the display screen of the associated larger display screen 108a, not the touch screen 126 of the personal mobile computing device 124a where the hidden menu 150 is located. In still other embodiments, the utility that is selectable and activatable affects both the display screen of the associated larger display screen 108a, and the touch screen 126 of the personal mobile computing device 124a where the hidden menu 150 is located.

In some other embodiments shown in FIGS. 6A and 6B, the hidden menu 170 is on the display screen of the associated larger display screen 108a and includes active regions 172, 174, 176, and 178 (in FIG. 6B) and inactive regions 182, 184, 186, and 188 (in FIG. 6B). Specifically, FIG. 6A shows the display screen of the associated larger display screen 108a with the hidden menu 170 not visible or active, while FIG. 6B shows the display screen of the associated larger display screen 108a with the hidden menu 170 visible and active.

In one or more aspects of some embodiments, the active regions 172, 174, 176, and 178 (in FIG. 6B) of the hidden menu 170 include utilities or other applications that are selectable and activatable via user input. Again, one such utility that is selectable and activatable is a zoom function that may be used to “zoom in” or “zoom out” on the display screen of the associated larger display screen 108a. Other utilities in some embodiments include settings changes on the display screen of the associated larger display screen 108a, including by way of example only, and not by way of limitation: brightness, contrast, tint, hue, color patterns, and the like. Still other utilities or applications may include by way of example only, and not by way of limitation: input source selection of content, internet web navigation, log-in operations, authentication operations, mapping and directions operations, reservation operations, voice command operations, and help functions. In another aspect of some embodiments, the inactive regions 182, 184, 186, and 188 (in FIG. 6B) do not include utilities or other applications that are selectable and activatable via user input, but rather include inactive data or content including by way of example only, and not by way of limitation: text, advertisements, information, instructions, art work, designs, non-interactive content, and the like.

Additionally, in some embodiments of a system for accessing hidden menus 150 on a display screen, the touch screen 126 receives a motion input user action. In various implementations, a motion input user action may take the form of a slide, swipe, pinch, expand, or other gesture motion with the input device (e.g., a user's finger(s)) being in contact with the user interface. In response to receiving the motion input user action on the touch screen 126, the system causes movement of the cursor 128a over the hidden menu 170 on the display screen of the associated larger display screen 108a.

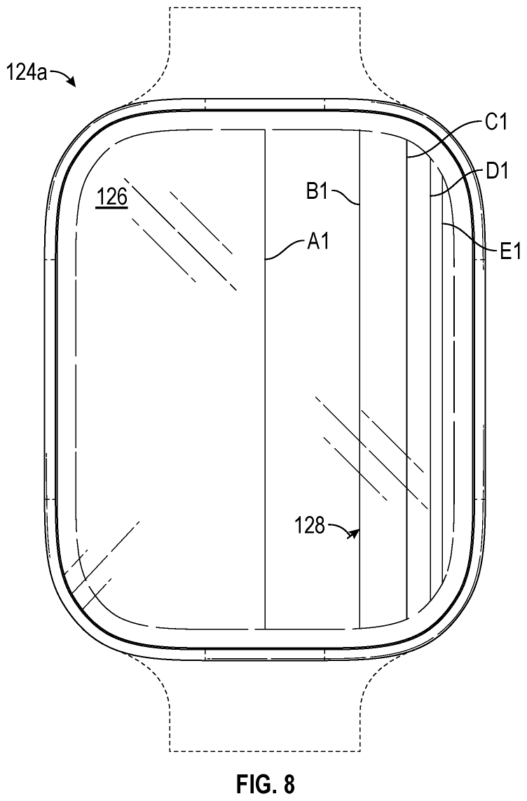

In some implementations, multiple concurrent gesture motions with multiple input devices (e.g., more than one of the user's fingers) being in contact with the touch screen 126 at the same time cause a different operation than a motion input user action from a single input device. For example, in some implementations, a multiple concurrent gesture motions with multiple input devices may cause a cursor 128a to move faster on the display screen than the gesture motion with a single input device. In other implementations, a multiple concurrent gesture motions with multiple input devices may cause a cursor 128a to move only between selectable active regions 172, 174, 176, and 178 on the hidden menu 170. This would make it easier for a user to select a specific active region and not accidentally move the cursor 128a to an inactive region 182, 184, 186, or 188, or even off of the hidden menu 170 completely. In yet another implementation, a multiple concurrent gesture motions with multiple input devices may cause a cursor 128a to move to the next grid line on the associated larger display screen 108a (e.g., from A2 to B2, B2 to C2, etc.) as shown on FIG. 9. In still another implementation, a multiple concurrent gesture motions with multiple input devices may cause movement between multiple active open applications and/or available content input sources on the associated larger display screen 108a.

In another aspect of some embodiments of a system for accessing hidden menus 150 on a display screen, the system receives a pressure user action on the touch screen 126. In one embodiment, the pressure user action is an applied pressure, in another embodiment, the pressure user action is a pressure release. An applied pressure user action occurs when the user applies a pressure to the screen. A pressure release user action occurs when the user removes a pressure from the screen. Such a pressure release user action may include lifting a user's finger or other input device (e.g., stylus, roller ball, or the like) off of the touch screen 126, thus, breaking contact with the touch screen. In response to receiving the pressure release user action, if the cursor 128a on the hidden menu 170 is over an active region 172, 174, 176, or 178 with a selectable utility, the system performs an operation associated with the selected utility. In another aspect of some embodiments, if the system receives the pressure release user action from the user lifting their finger or other input device off of the touch screen 126 while the cursor 128a is on the hidden menu 170 and is over an inactive region 182, 184, 186, or 188 (or even off of the hidden menu 170 completely), then the system de-activates the hidden menu 170.

The various examples provided herein are all described with respect to a pressure release user action for ease of description, but are also applicable to a pressure applied user action.

As described above, in some implementations the pressure input user action from a user finger press, the motion input user action from a user finger slide (e.g., while still in contact with the touch screen 126), and the pressure release user action from lifting a user's finger off of the touch screen 126, are all part of a connected, continuous touch, slide, and release user action by the user that cause an action to be taken by the processor in the device. Specifically, in one embodiment, the user will apply a pressure at one location on the screen, causing the hidden menu to appear, then, with the hidden menu present, the user slides their finger with pressure being applied so that it is now located over the desired action to be taken as stated at that location on the hidden menu. When user is over the location that contains the desired action, then the user releases their finger over that icon/instructions. This release of the finger is the pressure input, in this example, a pressure release, that provides the input signal to perform the action over which the finger was present when the pressure was released.

The action to be taken can be to bring up another application 150, a different menu, 162, perform a Zoom out, 154 or other desired function that is present on the hidden menu.

In other embodiments, the system may be able to detect the motion input user action without the input device (e.g., user finger, stylus, etc.) being in contact with the touch screen 126. Such a system includes non-contact detection and proximity sensors, such as laser triangulation sensors, laser displacement sensors, capacitive displacement sensors, photoelectric vibration sensors, or combinations thereof. In one or more embodiments of a non-contact detection system for accessing hidden menus 150 on a display screen, the pressure input user action may be from a user moving its finger into a detection zone or proximity to the touch screen 126, instead of the user contacting the touch screen 126. Additionally, in one or more embodiments of the non-contact detection system for accessing hidden menus 150 on a display screen, the pressure release user action may be from a user moving its finger out of a detection zone or proximity to the touch screen 126, instead of the user breaking contact with the touch screen 126.

In some implementations of the system for accessing hidden menus 150, the system activates a utility or application (or a feature of a utility or application) in response to the user moving the cursor 128a over an active region 172, 174, 176, or 178 of the hidden menu 170, without or before the release user action by a user. For example, in one such embodiment where one or more active regions relate to brightness, the user could move the cursor 128a over the one or more active regions related to brightness, using finger movement of the user on the touch screen 126 of the personal mobile computing device 124a, and produce various brightness levels of 50%, 60%, 70%, 80%, 90%, and 100% as the cursor 128a is moved back and forth over the active regions.

In another embodiment where the utility activated in response to the user moving the cursor 128a over an active region of the hidden menu 170 is a zoom feature, the pressure release user action performed is locking the zoom feature utility to be enabled. In still another embodiment, the system activates a zoom feature in response to the user moving the cursor 128a over an active region 172, 174, 176, or 178 of the hidden menu 170 (before a release user action occurs), and then when the release user action is initiated, the content presented on the display screen snaps back to its original non-zoomed size.

In another aspect of some embodiments of a system for accessing hidden menus 150 on a display screen, the system identifies various difference pressure release actions, including by way of example only, and not by way of limitation, a standard release, a swipe left release, a swipe right release, a swipe upwards release, a swipe downward release, and the like. In one such embodiment, the pressure release user action performed for the zoom feature utility if the cursor 128a on the hidden menu 170 is over an inactive region, involves deactivating the zoom feature and returning the content present on the display screen to a non-zooming mode. In another aspect of some embodiments, the operation associated with the pressure release user action on the touch screen 126 is the activation of a utility or application, or the activation of one or more features within the utility or application.

Referring now specifically to the location of the hidden menu 170 on the display screen of the of the associated larger display screen 108a, in yet another aspect of some embodiments, the hidden menu 170 on a display screen of the associated larger display screen 108a is positioned at a location associated with the received pressure input user action on the touch screen 126 of the personal mobile computing device 124a. In one such embodiment, if the user initiates a pressure input user action in the upper right quadrant of the touch screen 126, then the hidden menu 170 is launched in the upper right quadrant of the display screen of the associated larger display screen 108a. In another such embodiment, if the user initiates a pressure input user action in the lower left quadrant of the touch screen 126, then the hidden menu 170 is launched in the lower left quadrant of the display screen of the associated larger display screen 108a.

In contrast, in other embodiments, the hidden menu 170 on the display screen of the associated larger display screen 108a is positioned at a predetermined location that is not associated with the received pressure input user action on the touch screen 126 of the personal mobile computing device 124a. In one such embodiment, the hidden menu 170 is always launched in the upper right quadrant of the display screen of the associated larger display screen 108a, regardless of where the user initiates a pressure input user action on the touch screen 126.

In other embodiments, the display screen in FIG. 6B (or touch screen 126 in FIG. 5) upon which the hidden menu 170 in FIG. 6B (or hidden menu 150 in FIG. 5) is launched, is on one or more of an associated large display screen of an electronic device, a display screen/touch screen of the personal mobile computing device, and multiple connected display screens. As described herein, in some embodiments of a system for accessing hidden menus on a display screen, the display screen upon which the hidden menu is launched is on one or more of a smart watch, a mobile phone, a tablet computer, a desktop computer, a large screen television, and a large screen monitor.

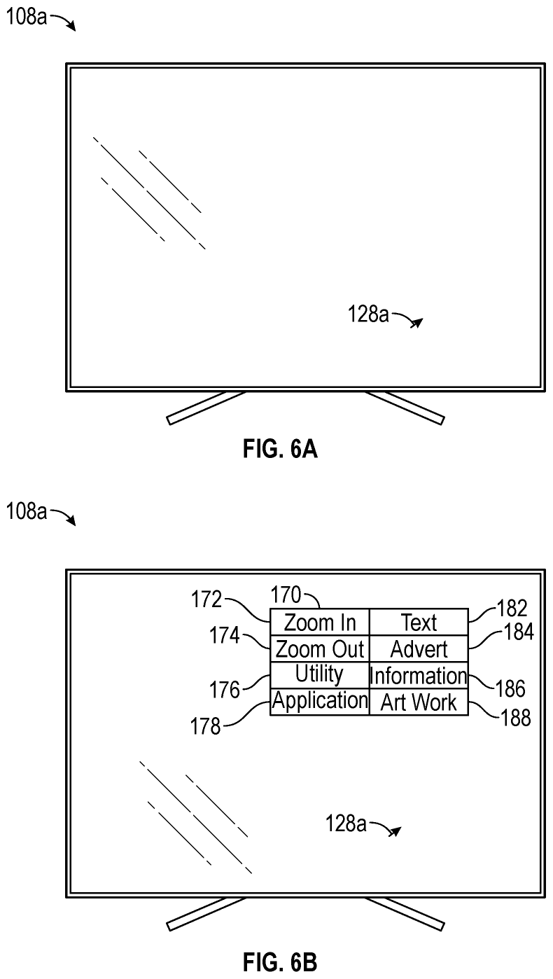

As shown in FIG. 7, embodiments of the present disclosure are also directed towards methods for accessing hidden menus on a display screen. As shown in FIG. 7, one such method includes: at 710, accessing a personal mobile computing device having a device memory that stores device computer instructions, and a device processor that executes the device computer instructions. Next at 720, the method recites: receiving a pressure input user action on a user interface. At 730, the method recites: activating a hidden menu on a display screen, in response to receiving the pressure input user action on a user interface. The hidden menu includes active regions and inactive regions. The active regions including utilities that are selectable and activatable via user input. Then at 740, the method includes: receiving a motion input user action on the user interface.

At 750, the method includes: causing movement of a cursor over the hidden menu on the user interface, in response to receiving the motion input user action on the user interface. Continuing, at 760, the method recites: receiving a pressure release user action on a user interface. Next, at 770, the method further includes: performing an operation associated with a utility, in response to receiving the pressure release user action if the cursor on the hidden menu is over an active region. Additionally, at 780, the method recites: de-activating the hidden menu, in response to receiving the pressure release user action if the cursor on the hidden menu is over an inactive region. Finally, at 790, the method recites: wherein the pressure input user action, the motion input user action, and the pressure release user action are all part of a touch and release user action by a user.

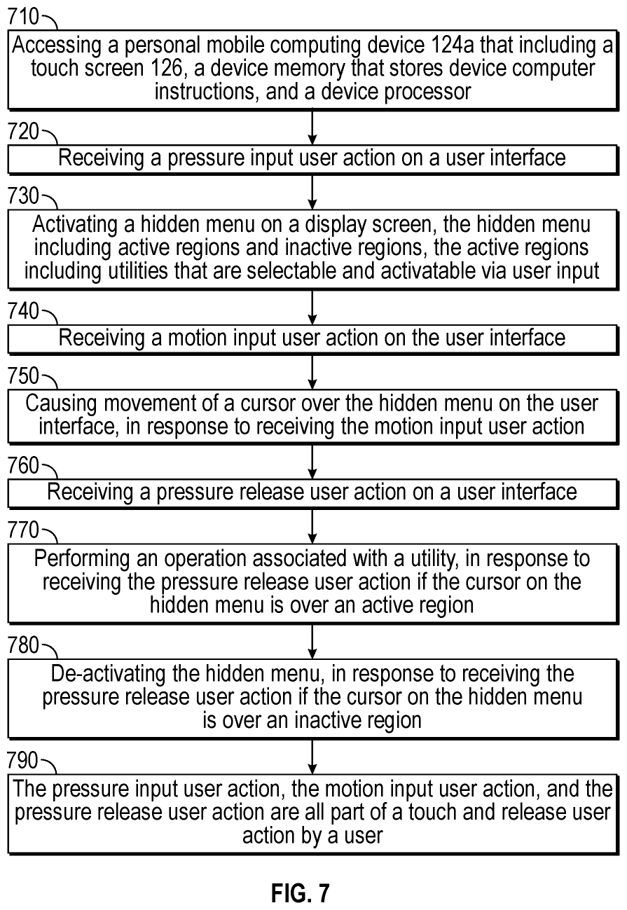

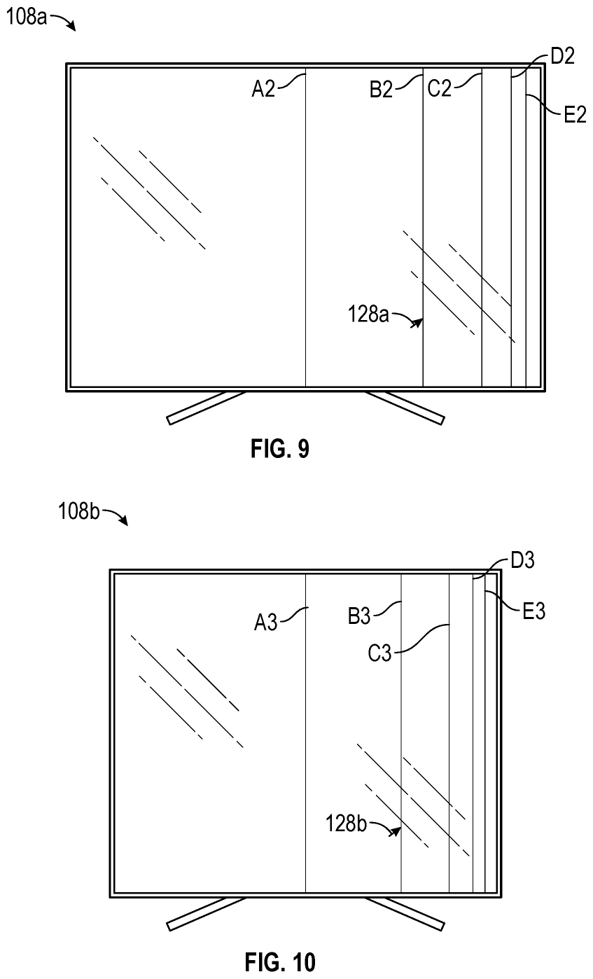

Referring now to FIGS. 8, 9, and 10, the system displays a user interface that may be accessed by a user having a processor-based personal computing device, such as a computer, smart phone, smart watch, or the like, such as the personal mobile computing devices 124 or display devices 108 shown in FIG. 1. Specifically, FIG. 8 shows a personal mobile computing device 124, FIG. 9 shows a larger screen display device 108a, and FIG. 10 shows a large screen display device 108b (but one that is smaller than the larger screen display device 108a of FIG. 9).

Some embodiments of a system and method for controlling cursor movement on an associated large display device 108a, 108b using dynamic grid density of the grid lines on the touch screen 126 of an associated personal mobile computing device 124a are described below. This system and method may also enable access to hidden menus on one or more display devices. Some such cursor movement control systems include a remote server 102 and a personal mobile computing device 124 with a touch screen 126 that has a dynamic grid density that increases towards the edges of the touch screen. The grid density of the grid lines on the personal mobile computing device refers to how close the grid lines are to each other for sensing the location of the touch input from a user. As the grid lines are closer to each other, the density if greater. Having a dynamic grid density for the touch screen grid means that the density of the touch screen grid can vary over time, based on the location on the display and/or based on changes of the input to the touch screen 126 of the personal associated display. The grid density is thus dynamic, namely it can vary based on the various conditions. In this manner, movement of the cursor 128 on the touch screen 126 of the personal mobile computing device 124a translates into a larger corresponding movement on the associated large display devices 108a, 108b depending on how close the cursor is to the edge of the touch screen 126.

The associated large display device also includes a dynamic grid density for displaying the location of the cursor. The grid density of the associated display device refers to the density of the grid lines for showing the location of a cursor on the screen or other objects on the display. As grid lines for showing displayed location get closer to each other, the density increases on the associated large display. Having a dynamic grid density means that the density of the grid can vary based on a number of different factors, for example, it can vary over time, based on a location on the display and/or based on changes of the input to the associated display. Thus, there is also a dynamic grid density for the associated large display device, but it is based on the display location of the large display. The large display is not a touch sensing display in one embodiment; in another embodiment it also contains a touch sensing grip with touch sensing capability. If the large display includes a touch sending grid, this will be different from its dynamic display grid.

Accordingly, movements of the cursor 128 that are closer to the edge of the touch screen 126 of the personal mobile computing device 124a correspond to large associated movements of the cursors 128a, 128b on the associated large display devices 108a, 108b, and movements of the cursor 128a that are closer to the center of the touch screen 126 of the personal mobile computing device 124a correspond to large associated movements of the cursors 128a, 128b on the associated large display devices 108a, 108b.

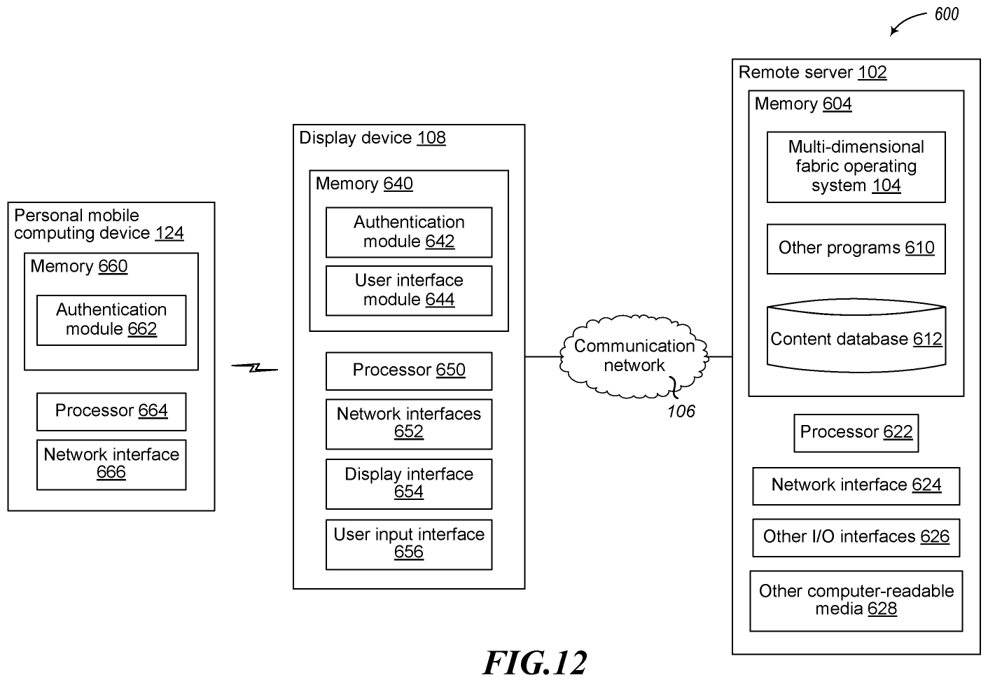

In some embodiments of the system and method for controlling cursor movement on an associated large display device 108a 108b using dynamic grid density on the touch screen 126, the personal mobile computing device 124a stores authentication information, includes a device memory that stores device computer instructions, and further includes a device processor that executes the stores device computer instructions. The device processor and device memory are described below in further detail with respect to FIG. 12.

The device processor executes the device computer instructions and causes the personal mobile computing device 124a to determine when it is within range of an associated large display device 108a or 108b. This may be performed using Wi-Fi, Bluetooth, Near Field Communication, or other appropriate sensing or communication technology. Next, the device processor executes further device computer instructions and causes the personal mobile computing device 124a to coordinate authentication between the personal mobile computing device and the remote server 102. In this manner, the system enables the personal mobile computing device 124a to link or pair with one of multiple different associated large display device 108a or 108b that do not need to have a pre-configured connection.

Once the personal mobile computing device 124a and one of the associated large display devices 108a or 108b are connected, via the remote server 102, the user may then submit user input, via the touch screen 126 of the personal mobile computing device 124a, to control cursor movement on the associated large display device 108a or 108b. As described in further detail below, the touch screen includes a grid (with grid lines that may or may not be visible) that increase in density towards the edges of the touch screen 126. The user input submitted by the user is then transmitted, via the above established connection, to the remote server 102 that calculates the cursor movement on the associated large display device 108a or 108b.

In some embodiments of the system and method for controlling cursor movement on an associated large display device 108a or 108b using dynamic grid density on the touch screen 126, the remote server 102 includes a server memory that stores device computer instructions, and includes a server processor that executes the stored server computer instructions. The server processor and server memory are described below in further detail with respect to FIG. 9.

The server processor executes the server computer instructions and causes the remote server 102 to calculate corresponding cursor movement on the associated large display device 108a or 108b using dynamic grid density on the touch screen 126 of the personal mobile computing device 124a that increases in density towards an edge of the touch screen. The dynamic grid density on the personal mobile computing device 124a controls how far the cursor 128a or 128b on the associated large display device 108a or 108b moves in response to the user input moving the cursor 128 on the touch screen 126 of the personal mobile computing device 124a. Once the corresponding movement of the cursor 128a or 128b on the associated large display device 108a or 108b has been calculated, the remote server 102 sends instructions to move the cursor 128a or 128b on the associated large display device 108a or 108b according to the calculated corresponding cursor movement.

Notably, in some embodiments of the system and method for controlling cursor movement on an associated large display device 108a or 108b using dynamic grid density on the touch screen 126, the corresponding cursor movement is calculated using the dynamic grid density without using a screen size of the associated large display device 108a or 108b in the calculation. In this manner, since the movement of the cursor 128 is characterized as a percentage of distance moved to the next grid line (e.g., from A1 to B1, from A2 to B2, etc.), rather than being characterizing in absolute distance (e.g., mm), the screen size does not need to be known by the personal mobile computing device 124a (or remote server) when the instructions for cursor movement are sent. For example, in response to the cursor 128 on the touch screen 126 of the personal mobile computing device 124a being moved 90% of the distance from grid line A1 to grid line B1, instructions may be sent to move the cursor 128a on the large screen of the associated large display devices 108a 90% of the distance from grid line A2 to grid line B2.

In FIGS. 8, 9, and 10, five grid lines (i.e., A1, B1, C1, D1, and E1) can be seen on the touch screen 126 of the personal mobile computing device 124a, five grid lines (i.e., A2, B2, C2, D2, and E2) can seen on the associated large display device 108a, and five grid lines (i.e., A3, B3, C3, D3, and E3) can seen on the associated large display device 108b. The first grid lines A2 and A3 are at the centerlines of the associated large display devices 108a, 108b, respectively. In this embodiment, each consecutive grid line (i.e., the second, third, fourth, and fifth grid line) are spaced at half of the remaining distance to the edge of the touch screen 126 and associated large display devices 108a, 108b. Thus, the grid density at E1, E2, and E3 is larger than the grid density at C1, C2, and C3. Additionally, the grid density at C1, C2, and C3 is larger than the grid density at A1, A2, and A3. As described above with respect of FIGS. 5 and 6B, one utility in an active region of a hidden menu 150 that is selectable and activatable, is a zoom function that may be used to “zoom in” or “zoom out” on the display screen of the associated larger display screen 108a, such as between grid lines D2 and E2. This zooming feature may be particularly useful in areas of high grid density.

Since the consecutive grid lines are each positioned half of the remaining distance to the edge of the personal mobile computing device 124a or associated large display devices 108a, 108b, this increasing grid line (or bounding box when in both vertical and horizontal directions) density alleviates problems with a user accidentally going off of the edge of the touch screen 126 with his or her finger or other input device. In some embodiments, these grid lines are not visible to a user of the system, while in other embodiments, the grid lines are visible to a user of the system.

While only vertical grid lines are shown on the respective personal mobile computing device and associated large display devices, horizontal grid lines are present on each device, both for the touch screen and the display screen, but are not shown for ease viewing the figures. Thus, the description and figures with respect to the vertical grid lines also applies to the horizontal grid lines that are present on each of the respective displays.

In some embodiments, the user may control the opacity of the grid lines so that they are visible enough to be useful for improved cursor movement purposes but not so visible that they are distracting from the information or content being displayed on touch screen 126 and associated large display devices 108a, 108b. Additionally, the dynamic grid density may vary between different embodiments of the system, with the grid line density being denser in some embodiments and less dense in other embodiments. Furthermore, while the grid lines of the touch screen (which represent dynamic grid density) are only shown in one direction in FIGS. 8, 9, and 10, in other embodiments, the grid lines are shown in two opposing directions (e.g., left and right, or top and bottom). In still other embodiments, the grid lines are shown in four directions (e.g., left, right, top, and bottom).

When the grid lines are shown in four directions, then the horizontal and vertical lines form bounding boxes. In some such embodiments, when the cursor is near the first grid line, which is a center line of a screen, then there are four bounding boxes. Next, in some such embodiments, when the cursor is near the grid line 2, which is half the distance to the edge of a screen in the embodiments of FIGS. 8, 9, and 10, then there are sixteen bounding boxes. In this manner, the movement of the cursor 128 on the touch screen 126 of the personal mobile computing device 124a moves the same percentage distance in a bounding box on the touch screen 126 of the personal mobile computing device 124a as a cursor 128a in a corresponding bounding box on the associated large display devices 108a. This increase in the number of bounding boxes continues for each additional grid line, as shown in FIGS. 8, 9, and 10, (e.g., 64 bounding boxes at grid line 3, 256 bounding boxes at grid line 4, and the like).

By looking at the movement of the cursor 128 on the touch screen 126 of the personal mobile computing device 124a (see grid line 2 on 126), and the corresponding movements of the cursors 128a, 128b on the associated large display devices 108a, 108b (see grid line 2 on 108a and 108b), it can be seen that the cursor movement on the associated large display devices 108a is the largest since that screen is the largest, and the cursor movement correlates to screen size in this embodiment of the system. For example, in some embodiments, a 5 mm movement on the touch screen 126 of the personal mobile computing device 124a from grid line A1 to grid line B1 translates to a 25 mm movement on the larger screen of the associated large display devices 108a from grid line A2 to grid line B2. Whereas, a 0.625 mm movement on the touch screen 126 of the personal mobile computing device 124a from grid line from grid line D1 to grid line E1 translates to a 3.125 mm movement on the larger screen of the associated large display devices 108a from grid line D2 to grid line E2. In this embodiment, A1-B1 is 5 mm, B1-C1 is 2.5 mm, C1-D1 is 1.25 mm, and D1-E1 is 0.625 mm while A2-B2 is 25 mm, B2-C2 is 12.5 mm, C2-D2 is 6.25 mm, and D2-E2 is 3.125 mm.

In other embodiments of the system, the cursor movement does not correlate directly to screen size, but still relates to larger cursor movements on larger screens and relates to smaller cursor movements on smaller (but still large) screens, in comparison to the touch screen 126 of the personal mobile computing device 124a.

In some embodiments of the system and method for controlling cursor movement on an associated large display device 108a or 108b using dynamic grid density on the touch screen 126, the larger associated large display devices 108b have a higher dynamic grid density toward edges of their touch screens than smaller associated large display devices 108a. In other embodiments, the smaller associated large display devices 108a have a lower dynamic grid density toward their edges than larger associated large display devices 108b. In another aspect of some embodiments of the system, the user's input device is one of a finger, a stylus, a digital pen, or other input device, that the user utilizes to submit cursor control movements into his or her touch screen 126 to control cursor movements on connected larger associated large display devices 108a or 108b.

In one or more embodiments of the system, the touch screen 126 of the personal mobile computing device 124a has four edges and the dynamic grid density increases from a center of the touch screen 126 towards any of the four edges of the touch screen 126. In some other embodiments, while the touch screen 126 of the personal mobile computing device 124a still has four edges, the dynamic grid density increases from a center of the touch screen 126 towards only two of the four edges of the touch screen 126. In one aspect, some embodiments of the system and method have a dynamic grid density that increases linearly from the center of the touch screen 126 towards one or more edges of the touch screen 126. In another aspect, some embodiments of the system and method have a dynamic grid density that increases geometrically from the center of the touch screen 126 towards one or more edges of the touch screen 126, while other embodiments of the system and method have a dynamic grid density that increases exponentially from the center of the touch screen 126 towards one or more edges of the touch screen 126.

In still another aspect of some embodiments, the received input from the user is sent from the personal mobile computing device 124a to the remote server 102 where the input is processed in association with the dynamic grid density. In some such embodiments, the instructions to move the cursor on the associated large display device 108a or 108b relative to the calculated corresponding cursor movement are then sent from the remote server 102 to the associated large display device 108a or 108b. Thus, in such embodiments of the system and method for controlling cursor movement, the corresponding cursor movement is calculated using the dynamic grid density without using a screen size of the associated large display device 108a or 108b in the calculation. Otherwise stated, in some embodiments, the personal mobile computing device 124a does not need to know the screen size of the associated large display device 108a or 108b in order to send appropriate cursor movement control signals to it with the touch screen 126 of the personal mobile computing device 124a.

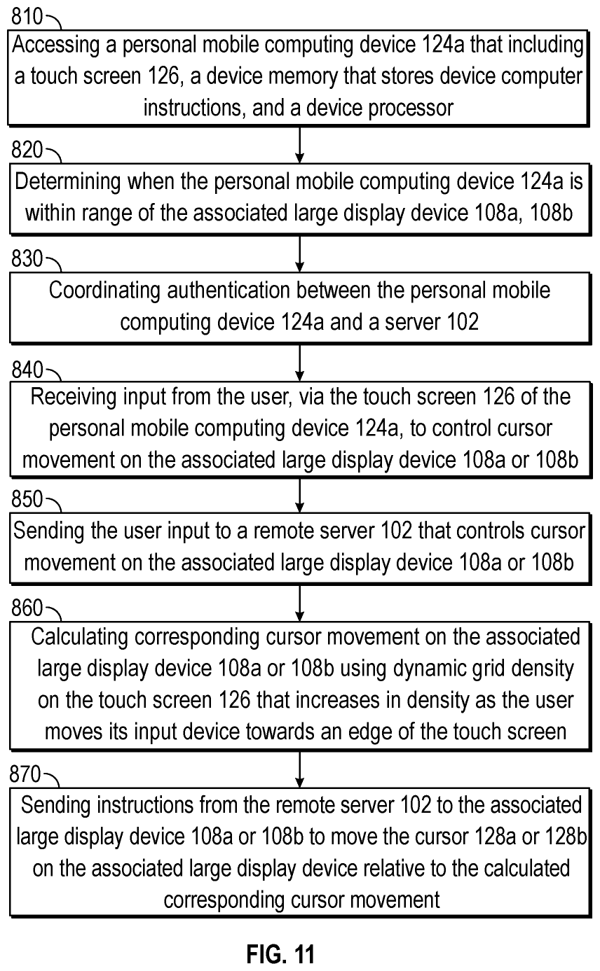

Embodiments of the present disclosure are also directed towards methods for controlling cursor movement on an associated large display device 108a or 108b using dynamic grid density of the touch screen 126 on an associated personal mobile computing device 124a. As shown in FIG. 11, one such method includes: at 810, accessing a personal mobile computing device 124a that stores authentication information, the personal mobile computing device including a touch screen 126, a device memory that stores device computer instructions, and a device processor. Next at 820, the method recites, determining when the personal mobile computing device 124a is within range of the associated large display device 108a, 108b. Then at 830, the method includes coordinating authentication between the personal mobile computing device 124a and a remote server 102.

Continuing, at 840, the method recites receiving input from the user, via the touch screen 126 of the personal mobile computing device 124a, to control cursor movement on the associated large display device 108a or 108b, the touch screen including a grid that increases in density towards the edges of the touch screen 126. Next, at 850, the method further includes sending the user input to a remote server 102 that controls cursor movement on the associated large display device 108a or 108b.

Additionally, at 860, the method recites: calculating, using the remote server 102, corresponding cursor movement on the associated large display device 108a or 108b using dynamic grid density on the touch screen 126 of the personal mobile computing device 124a that increases in density as the user moves its input device towards an edge of the touch screen. The dynamic grid density on the personal mobile computing device 124a controls how far the cursor 128a or 128b on the associated large display device 108a or 108b moves in response to the user input on the touch screen 126 of the personal mobile computing device 124a.

Finally, at 870, the method also includes sending instructions from the remote server 102 to the associated large display device 108a or 108b to move the cursor 128a or 128b on the associated large display device 108a or 108b relative to the calculated corresponding cursor movement. The corresponding cursor movement is calculated using the dynamic grid density without using a screen size of the associated large display device 108a or 108b in the calculation. In this manner, since the movement of the cursor 128 is characterized as a percentage of distance moved to the next grid line (e.g., from C1 to D1, from C2 to D2, etc.), rather than being characterizing in absolute distance (e.g., mm), the screen size does not need to be known by the personal mobile computing device 124a (or remote server) when the instructions for cursor movement are sent. For example, in response to the cursor 128 on the touch screen 126 of the personal mobile computing device 124a being moved 70% of the distance from grid line C1 to grid line D1, instructions may be sent to move the cursor 128b on the large screen of the associated large display devices 108b 70% of the distance from grid line C2 to grid line D2.

In some other embodiments of the method for controlling cursor movement on an associated large display device 108a or 108b using dynamic grid density on the touch screen 126, some of the operations described above are removed from the process. For example, in some embodiments, operations 820 and 830 are removed from the process because these authentication techniques are not implemented by these embodiments. In still other embodiments of the method for controlling cursor movement on an associated large display device 108a or 108b using dynamic grid density on the touch screen 126, other operations in addition to those described above are added to the process.

In other embodiments of the system and method for controlling cursor movement on an associated large display device 108a or 108b using dynamic grid density on the touch screen 126, the personal mobile computing devices 124 are able to send cursor movement control information directly to the associated large display device 108a or 108b for controlling cursor movement on the associated large display device, instead of being sent to the remote server 102 for cursor control movement calculation and retransmission. In such an embodiment, the calculation of the cursor control movement is performed by the processor of the personal mobile computing devices 124, instead of the server processor of the remote server 102. This alternate embodiment may be needed in certain situations, such as by way of example only, and not by way of limitation, such as (1) situations where there is no Wi-Fi are other transmission means available for connecting with the remote server 102, (2) situations where the transmission latency transmitted to the remote server 102 and then back to the associated large display device 108a or 108b is unacceptably large for the current application or use case, and (3) situations where there are security advantages from using a direct transmission from the personal mobile computing devices 124 to the associated large display device 108a or 108b.

FIG. 12 shows a system diagram that describes one implementation of computing systems for implementing embodiments described herein. System 600 includes remote server 102, one or more associated large display devices 108a and 108b, and one or more personal mobile computing devices 124.

As described herein, the remote server 102 is a computing device that can perform functionality described herein for implementing an operating system that provides a multi-dimensional fabric user interface for storing content. One or more special purpose computing systems may be used to implement the remote server 102. Accordingly, various embodiments described herein may be implemented in software, hardware, firmware, or in some combination thereof. The remote server 102 includes memory 604, one or more processors 622, network interface 624, other input/output (I/O) interfaces 626, and other computer-readable media 628. In some embodiments, the remote server 102 may be implemented by cloud computing resources.

Processor 622 includes one or more processing devices that execute computer instructions to perform actions, including at least some embodiments described herein. In various embodiments, the processor 622 may include one or more central processing units (“CPU”), programmable logic, or other processing circuitry.

Memory 604 may include one or more various types of non-volatile and/or volatile storage technologies. Examples of memory 604 include, but are not limited to, flash memory, hard disk drives, optical drives, solid-state drives, various types of random-access memory (“RAM”), various types of read-only memory (“ROM”), other computer-readable storage media (also referred to as processor-readable storage media), other memory technologies, or any combination thereof. Memory 604 may be utilized to store information, including computer-readable instructions that are utilized by processor 622 to perform actions, including at least some embodiments described herein.

Memory 604 may have stored thereon multi-dimensional fabric operating system 104. The multi-dimensional fabric operating system 104 authenticates users of personal mobile computing devices 124 via display devices 108 and provides a user interface of a multi-dimensional fabric for storing and accessing content, as described herein.

Memory 604 may include a content database 612 for storing content in accordance with the multi-dimensional fabric user interface. Memory 604 may also store other programs 610. The other programs 610 may include other operating systems, user applications, or other computer programs that are accessible to the personal mobile computing device 124 via the display device 108.

Network interface 624 is configured to communicate with other computing devices, such as the display devices 108, via a communication network 106. Network interface 624 includes transmitters and receivers (not illustrated) to send and receive data associated with the multi-dimensional fabric user interface described herein.

Other I/O interfaces 626 may include interfaces for various other input or output devices, such as audio interfaces, other video interfaces, USB interfaces, physical buttons, keyboards, haptic interfaces, tactile interfaces, or the like. Other computer-readable media 628 may include other types of stationary or removable computer-readable media, such as removable flash drives, external hard drives, or the like.

The display devices 108 are computing devices that are remote from the remote server 102. In some embodiments, the display devices 108 may include one or more computing devices and display devices. The display devices 108 coordinate authentication between the personal mobile computing devices 124 and the remote server 102. The display devices 108 receive input from the users of the personal mobile computing device 124 and provide the input to the remote server 102. The display devices 108 receive the graphical user interfaces for the multi-dimensional fabric user interface to be presented to the users of the personal mobile computing devices 124.

One or more special-purpose computing systems may be used to implement the display devices 108. Accordingly, various embodiments described herein may be implemented in software, hardware, firmware, or in some combination thereof.

The display devices 108 include memory 640, one or more processors 650, network interface 652, display interface 654, and user input interface 656. The memory 640, processor 650, and network interface 652 may be similar to, include similar components, or incorporate embodiments of memory 604, processor 622, and network interface 624 of remote server 102, respectively. Thus, processor 650 includes one or more processing devices that execute computer instructions to perform actions, including at least some embodiments described herein. In various embodiments, the processor 650 may include one or more CPUs, programmable logic, or other processing circuitry. The network interfaces 652 is also configured to communicate with the personal mobile computing devices 124, such as via Bluetooth or other short-range communication protocol or technology.

Memory 640 may include one or more various types of non-volatile and/or volatile storage technologies. Memory 640 may be utilized to store information, including computer-readable instructions that are utilized by processor 650 to perform actions, including at least some embodiments described herein. Memory 640 may store various modules or programs, including authentication module 642 and user interface module 644. The authentication module 642 may perform actions that coordinate the authentication between the personal mobile computing devices 124 and the remote server 102. The user interface module 644 receives graphical user interface data from the remote server 102 for display or presentation, via the display interface 654, to the user of the personal mobile computing devices 124. The user interface module 644 also receives user input via the user input interface 656 and provides that input back to the remote server 102. In various embodiments, one or more capacitive, radar, infrared, LIDAR, or other type of gesture capturing sensors may be used to receive the user input. In some other embodiments, the user interface module 644 may receive user inputs via other input mechanisms, such as a mouse, stylus, voice-recognition, or other input sensors. Memory 640 may also store other programs.

The personal mobile computing devices 124 are computing devices that are remote from the display devices 108 and the remote server 102. When a personal mobile computing device 124 is within a threshold range of the display device 108 or when a user of the personal mobile computing device 124 activates authentication, the personal mobile computing device 124 provides authentication data or information to the display device 108 for forwarding to the remote server 102. In various embodiments, the personal mobile computing device 124 is separate from the display device 108, such that a user can walk up to a display device 108 with the personal mobile computing device 124 to initiate the process described herein to have the display device 108 present the user interface of the multi-dimensional fabric received from the remote server 102. The user can then provide input to the display device 108, such as with hand gestures or arm movement, to manipulate the multi-dimensional fabric user interface and select content for display.

One or more special-purpose computing systems may be used to implement the personal mobile computing devices 124. Accordingly, various embodiments described herein may be implemented in software, hardware, firmware, or in some combination thereof.

The personal mobile computing devices 124 include memory 660, one or more processors 664, and a network interface 666. The memory 660, processor 664, and network interface 666 may be similar to, include similar components to, or incorporate embodiments of memory 640, processor 650, and network interfaces 652 of display devices 108, respectively. Thus, processor 664 includes one or more processing devices that execute computer instructions to perform actions, including at least some embodiments described herein. In various embodiments, the processor 664 may include one or more CPUs, programmable logic, or other processing circuitry. The network interface 666 is configured to communicate with the display devices 108, but not with the remote server 102.

Memory 660 may include one or more various types of non-volatile and/or volatile storage technologies. Memory 660 may be utilized to store information, including computer-readable instructions that are utilized by processor 650 to perform actions, including at least some embodiments described herein. Memory 660 may store various modules or programs, including authentication module 662. The authentication module 662 may perform actions to communicate authentication information to a display device 108 when within a threshold distance from the display device or when activated by a user.

The various embodiments described above can be combined to provide further embodiments. These and other changes can be made to the embodiments in light of the above-detailed description. In general, in the following claims, the terms used should not be construed to limit the claims to the specific embodiments disclosed in the specification and the claims but should be construed to include all possible embodiments along with the full scope of equivalents to which such claims are entitled. Accordingly, the claims are not limited by the disclosure.

1. A system for accessing hidden menus on a display screen, the system comprising:
a personal mobile computing device that stores authentication information, the personal mobile computing device including a device memory that stores device computer instructions and a device processor that when executing the device computer instructions causes the personal mobile computing device to:
coordinate authentication between the personal mobile computing device and a display screen;
receive an applied pressure input user action on a user interface;
activate a hidden menu on the display screen, in response to receiving the pressure input user action on a user interface, the hidden menu including active regions and inactive regions, the active regions including utilities that are selectable and activatable via user input;
receive a motion input user action on the user interface;
cause movement of a cursor over the hidden menu on the user interface, in response to receiving the motion input user action on the user interface;
receive a pressure release user action on the user interface;
perform an operation associated with a utility, in response to receiving the pressure release user action if the cursor on the hidden menu is over an active region; and
de-activate the hidden menu, in response to receiving the pressure release user action if the cursor on the hidden menu is over an inactive region;
wherein the applied pressure input user action, the motion input user action, and the pressure release user action are all part of a single touch and release user action by a user.

2. The system of claim 1, wherein the device processor executes further device computer instructions that further cause the system to:
enable activation of a utility in response to the user moving the cursor over an active region of the hidden menu.

3. The system of claim 2, wherein the utility activated in response to the user moving the cursor over an active region of the hidden menu is a zoom feature.

4. The system of claim 3, wherein the pressure release user action performed for the zoom feature utility if the cursor on the hidden menu is over an active region is locking the zoom feature utility to be enabled.

5. The system of claim 3, wherein the pressure release user action performed for the zoom feature utility if the cursor on the hidden menu is over an inactive region is deactivating the zoom feature and returning to a non-zooming mode.

6. The system of claim 1, wherein the operation associated with the pressure release user action on the user interface is the activation of the utility.

7. The system of claim 1, wherein the hidden menu on a display screen is positioned at a location associated with the received pressure input user action on a user interface.

8. The system of claim 1, wherein the hidden menu on a display screen is positioned at a predetermined location that is not associated with the received pressure input user action on a user interface.

9. The system of claim 1, wherein the display screen upon which the hidden menu is launched is on one or more of an associated large display screen of an electronic device, a display screen of the personal mobile computing device, and multiple connected display screens.

10. The system of claim 1, wherein the display screen upon which the hidden menu is launched is on one or more of a smart watch, a mobile phone, a tablet computer, a desktop computer, a large screen television, and a large screen monitor.

11. A method for accessing hidden menus on a display screen, the method comprising:
accessing a personal mobile computing device, the personal mobile computing device including a device memory that stores device computer instructions and a device processor that executes the device computer instructions;
receiving a pressure input user action on a user interface;
activating a hidden menu on a display screen, in response to receiving the pressure input user action on a user interface, the hidden menu including active regions and inactive regions, the active regions including utilities that are selectable and activatable via user input;
receiving a motion input user action on the user interface;
causing movement of a cursor over the hidden menu on the user interface, in response to receiving the motion input user action on the user interface;
receiving a pressure release user action on a user interface;
performing an operation associated with a utility, in response to receiving the pressure release user action if the cursor on the hidden menu is over an active region; and
de-activating the hidden menu, in response to receiving the pressure release user action if the cursor on the hidden menu is over an inactive region,
wherein the pressure input user action, the motion input user action, and the pressure release user action are all part of a touch and release user action by a user.

12. The method of claim 11, further comprising:
enabling activation of a utility in response to the user moving the cursor over an active region of the hidden menu.

13. The method of claim 12, wherein the utility activated in response to the user moving the cursor over an active region of the hidden menu is a zoom feature.

14. The method of claim 13, wherein the pressure release user action performed for the zoom feature utility if the cursor on the hidden menu is over an active region is locking the zoom feature utility to be enabled.

15. The method of claim 13, wherein the pressure release user action performed for the zoom feature utility if the cursor on the hidden menu is over an inactive region is deactivating the zoom feature and returning to a non-zooming mode.

16. The method of claim 11, wherein the operation associated with the pressure release user action on the user interface is the activation of the utility.

17. The method of claim 11, wherein the hidden menu on a display screen is positioned at a location associated with the received pressure input user action on a user interface.

18. The method of claim 11, wherein the hidden menu on a display screen is positioned at a predetermined location that is not associated with the received pressure input user action on a user interface.

19. The method of claim 11, wherein the display screen upon which the hidden menu is launched is on one or more of an associated large display screen of an electronic device, a display screen of the personal mobile computing device, and multiple connected display screens.

20. The method of claim 11, wherein the display screen upon which the hidden menu is launched is on one or more of a smart watch, a mobile phone, a tablet computer, a desktop computer, a large screen television, and a large screen monitor.

21. A system for accessing hidden menus on a display screen, the system comprising:
a personal mobile computing device including a device memory that stores device computer instructions and a device processor that when executing the device computer instructions causes the system to:
activate a hidden menu on a display screen, in response to receiving a first input user action on a user interface, the hidden menu including active regions and inactive regions, the active regions including utilities that are selectable and activatable via user input;
cause movement of a cursor over the hidden menu on the user interface, in response to receiving a motion input user action on the user interface;
perform an operation associated with a utility, in response to receiving the second input user action if the cursor on the hidden menu is over an active region; and
de-activate the hidden menu, in response to receiving the pressure release user action.

22. The system of claim 21, wherein the first input user action is an applied pressure.

23. The system of claim 21, wherein the first input user action is a released pressure.

24. The system of claim 21, wherein the second input user action is an applied pressure.

25. The system of claim 21, wherein the second input user action is a released pressure.

26. The system of claim 21, wherein the user interface is on a smart watch, a mobile phone, a tablet computer, a desktop computer, a large screen television, or a large screen monitor.

27. The system of claim 21, wherein each of the first input user action, the motion input user action, and the second input user action are location inputs of an input device positioned directly over the display, without touching the display.
